(19) United States
(12) Patent Application Publication
(10) Pub. No.: US 2012/0192688 A1
(43) Pub. Date: Aug. 2, 2012

(54) PUNCH TOOL AND METHOD FOR ROTARY BLADES

(76) Inventor: LARRY ALLEN, MCKENZIE, TN (US)

(21) Appl. No.: 13/016,314

(22) Filed: Jan. 28, 2011

(51) Int. Cl. B26F 1/14; B26F 1/00

(52) U.S. Cl. 83/13; 83/685

(57) ABSTRACT

A two piece punch and die button tool is used to punch a hole in a rotary mower blade. The upper punch has a circumferential radius that forms a circumferential radius in the upper side of the hole. The lower die button has a circumferential radius that forms a circumferential radius in the lower side of the hole. The upper and lower circumferential radii of the holes reduces stress risers in the hole and increases the durability and safety of the blade. The punch and die button form the circumferential radii with one stroke of the machine.

### BACKGROUND OF INVENTION

This invention relates to the field of rotary cutter blades. More particularly, a two-piece, one-stroke hot forged punch tool for punching the attaching hole in a rotary blade is presented.

In the rotary mower industry, it is necessary to forge strong and safe replaceable blades for the rotating mechanisms of mowers. Common mower manufacturers such as Bush Hog® use interchangeable blades for their mower units. These blades are attached to the mower mechanism using bolts. The blades must be manufactured to exacting tolerances. Each blade must have an attaching hole in one end used to secure the blade to the mower body by the attaching bolt.

Blade breakage at the attaching hole is a major problem in the industry since the blades oscillate on the attaching bolts when the mower unit is in motion. It is vitally important to have a strong area where the oscillation occurs to insure the safety and durability of the blade.

For safety and durability reasons, rotary blades are normally manufactured from spring steel that is milled and heat treated and cut to precise specifications. The upper and lower blade surfaces must be parallel within AISI HR tolerances. Some blades, for example, are made from hot rolled steel bars from ASTM standard A304 steel 5150/5160 fine grain as per A304 Supplementary Regulation 8. The blades are heat treated and must comply with ANSI/ASAE Standard S483. The heat treated steel has a yield strength of approximately 170,000 psi and a tensile strength of approximately 200,000 psi. It is an important object of this invention to reduce the stress on the blade at the hole by the method and with the tool disclosed below.

Other blades may have other precise requirements, but the tolerances and composition of the blades are of critical importance for safety and other reasons. The holes in the blades are normally manufactured by hot punching at approximately 1650 degrees F. or by cold punching the steel blades at ambient temperature.

Since the rotary blades oscillate rapidly up and down on the attaching bolt as they spin when the mower is in motion, the location and strength of the hole in the blade is a very important design feature. Although uncommon, if the blade fails at the hole the blade becomes a very dangerous and perhaps lethal flying projectile. Such blade failures often result in catastrophic losses and injury. It is an object of this invention to provide a tool and method for producing a stronger and safer hole in a mower blade.

Stress risers are areas on a piece of metal where forces accumulate and are susceptible of increased failure due to design and manufacturer issues. Sharp edges or bends in metal, such as are created by the normal punch and die method, create heightened stress along the top and bottom edges of the hole that was punched from the metal blade. Due to this problem, one area of special attention in the design of rotary mower blades is the design, creation and manufacture of the attaching hole.

A common method of manufacturing rotary mower blades is to simply punch the attaching hole through the blade. This method forms perpendicular edges and sides in the area from the top of the hole to the bottom of the hole. These perpendicular sharp edges between the top and bottom and sides at the blade attaching hole create added stress to the blade unit, particularly at the hole-bolt location. Although this common method is cheap and requires no special tooling, it is not ideal due to the creation of subsequent stress risers at the blade hole. It is an object of this invention to provide a special tool and method to create an attaching hole in a rotary cutter blade that reduces the stress risers for the unit thereby making a safer blade.

Some manufacturers have designed tools and methods to create a flat bevel cut chamfer on one side of the hole. The bevel reduces the stress riser, although stress risers are created at the beveled edges. The stress in a chamfered type of hole is less than straight cut holes, and a stronger hole and blade is manufactured through the utilization of this type of hole punching and forming. However, the chamfer does create sharp edges.

Most blade failures, including chamfered blade holes fail on the bottom side of the hole. It would be desirable if a hole in a rotary cutter blade could be produced which reduces the stress risers even more than a chamfered hole. It is an object of this invention to provide a solution to the problem of stress risers in rotary cutter blade holes.

After much research and thought given to the problem of stress in rotary cutter blades, the instant invention discloses a curved radius formed on both the top and bottom surfaces of the hole to reduce the stress risers necessarily created during the hole-punching operation.

The stress on the blade diminishes as the radius goes deeper into the hole created by the tool and process. However, due to the tolerances necessary in the manufacturing process, the radius must have more or less precise dimensions to be effective. After much experimentation, the ideal radius for both the top and bottom radii were determined. Safety engineers were surprised at the new innovation and immediately accepted the concept of manufacturing top and bottom radii to reduce the stress risers inherent in the hole punching procedure.

As an added feature, the tool of the instant invention and the method used to produce the hole have been designed to produce an efficient and cost effective manufacturing operation. While some manufacturing processes related to hole creation in rotary mower blades use a multiple stroke process to punch the hole and produce the chamfer in the blade, the instant tool and process use a one-stroke operation. It is a still further object of this invention to disclose a tool and process that utilizes a one-stroke process for creating the hole in a rotary mower blade.

As a primary object, the instant invention helps to greatly reduce the stress risers at the blade hole by creating a curvature or radius on both the top and bottom of the hole in one manufacturing stroke. This is accomplished by using a one-stroke, two piece process for creating a radius on both the top and bottom of the attaching hole in a rotary mower blade. By using the disclosed tool and process, the safety of the blades manufactured is greatly improved and the life of the blade is increased over other blades not utilizing the instant design and manufacturing process.

### BRIEF DESCRIPTION OF THE DEVICE

A two piece punch and die button tool is used to punch an attaching hole into one end of a rotary cutter blade. The punch and die button are used to punch the hole and form the radii in the steel blade. The top punch has a circular circumferential curvature such that the top circumference of the blade hole punched has a radius formed in it that extends downwardly into the hole. The bottom die button also has a circular radius formed in it such that the bottom circumference of the blade hole has an inwardly and upwardly radius formed in it. The upper and lower radii lessen the stress to the metal at the hole and increase the safety and durability of the blade at the hole location.

### BRIEF DESCRIPTION OF THE DRAWING FIGURES

FIG. 1 is a perspective view of a rotary cutter blade.

FIG. 2 is a partial side cross-section of the blade and bolt assembly.

FIG. 3 is a side cross-section of the finished blade showing the hole with inner radii.

FIG. 4 is a side view of the upper hot punch piece of the tool.

FIG. 4A is a side view of the lower die button piece of the tool.

FIG. 5 is a partial side view of the left upper radius of the punch.

FIG. 6 is a partial cross-section of the finished upper left radius of the blade.

FIG. 7 is a partial side cross section of the lower left die button.

FIG. 8 is a partial cross-section of the finished lower left radius of the blade.

### DETAILED DESCRIPTION OF THE INVENTION

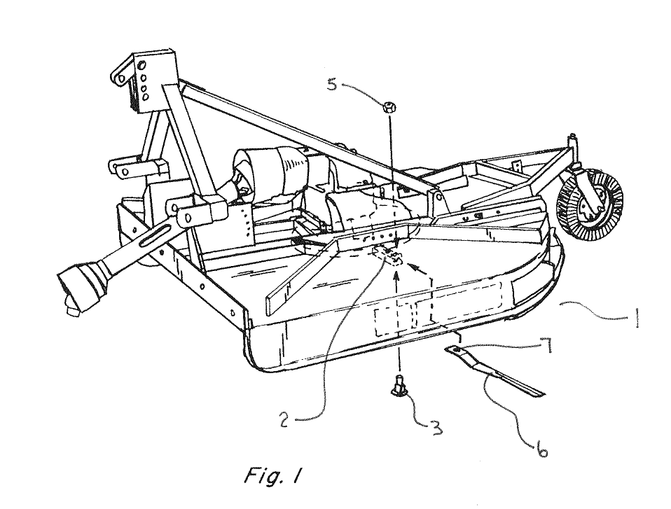

A plurality of rotary cutter blades 6 are replaceably and interchangeably attached to a mower deck 1 as shown in FIG. 1. The lower part of the mower deck has a brace 2 for receiving the blade bolt 3. The blades 6 rotate at a very high rate of speed when the mower is in operation. Secure, safe, durable attachment of the blade 6 to the mower deck is of paramount importance.

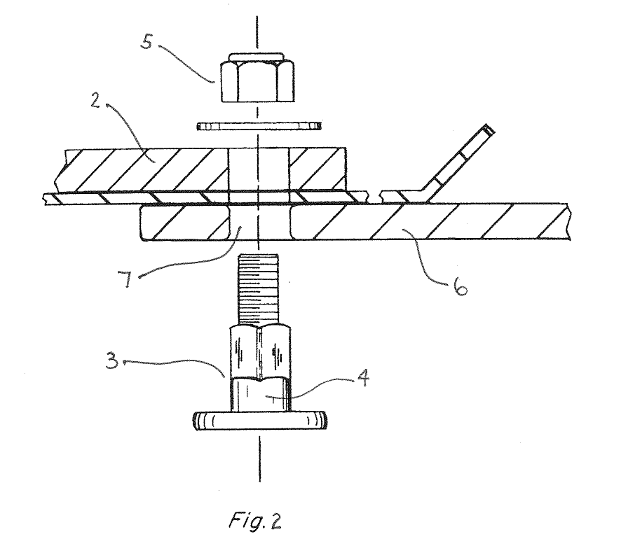

As best shown in FIG. 2, the blade bolt 3 has a lower smooth circular shaft 4. The blade 6 is attached at blade brace 2 by placing bolt 3 through the blade hole 7. The blade brace 2 is attached to the mower deck. The blade 6 is secured to the blade brace 2 by the bolt 3 and nut 5. The blade 3 is able to rotate about the smooth shaft 4 of the bolt 3 when the blade is in motion but hits an obstruction like a tree stump or other unexpected obstruction.

The blades 6 are made of spring steel that is milled and heat treated. The blade stock is initially flat but is bent into the desired shape generally as shown in FIG. 1. Both sides of the steel blade are flat and parallel according to exacting standards.

In order to attach the blades to a rotary cutter unit, an attaching hole must be created in one end of the blade. In the normal manufacturing process heretofore utilized in the industry this hole is simply punched, leaving sharp perpendicular edges at the top and bottom of the hole, although many blades have a bottom chamfer. Any sharp edges create stress risers. Most rotary blades fail at the bottom edge of the blade.

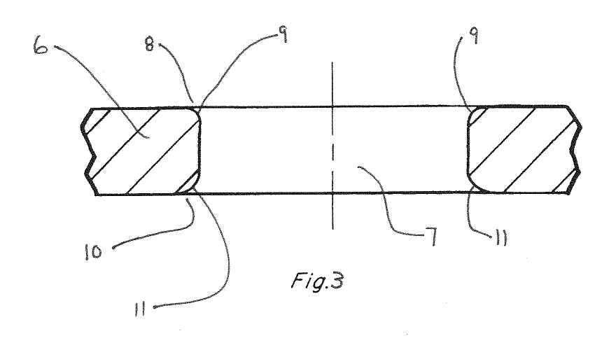

FIG. 3 is a partial view of a blade 6 manufactured according to the new method and with the new tool disclosed in this application. The top edge 8 of the blade 6 having a hole 7 is inwardly and downwardly curved as shown. This design and creation of this upper curvature or radius 9 is more fully described later in this Specification. The bottom edge 10 of the hole 7 also has a curvature or radius 11 as shown. The bottom radius is inwardly and upwardly curved as shown. The design and curvature of this bottom radius 11 is more fully described in the Specification below.

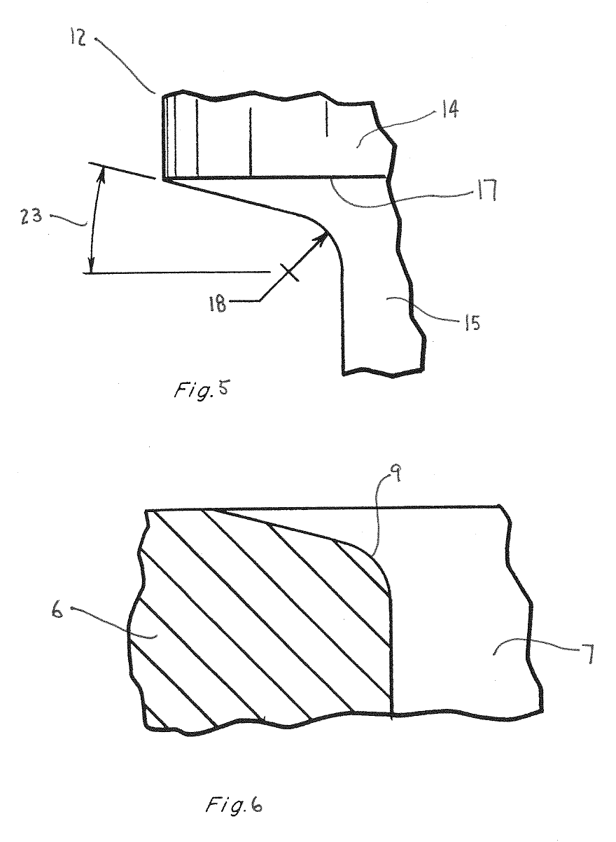

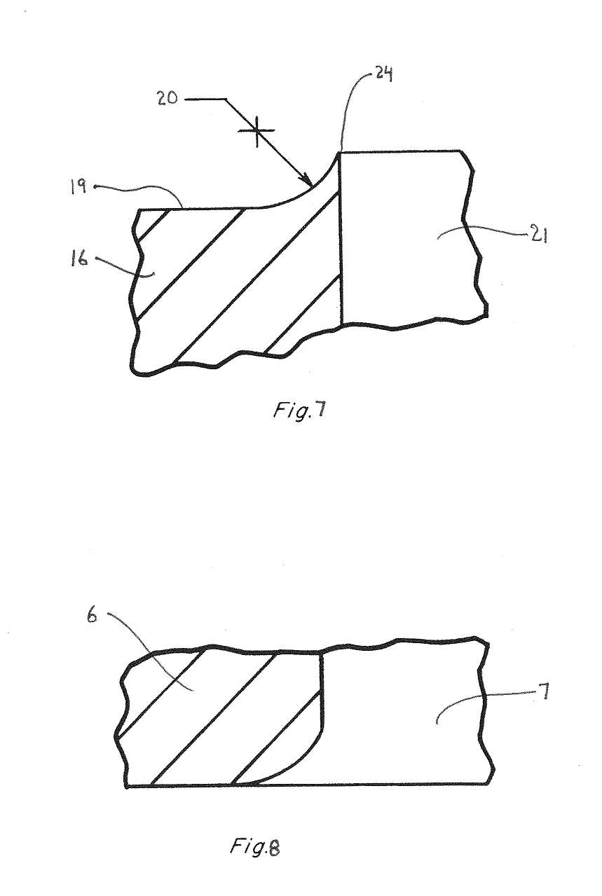

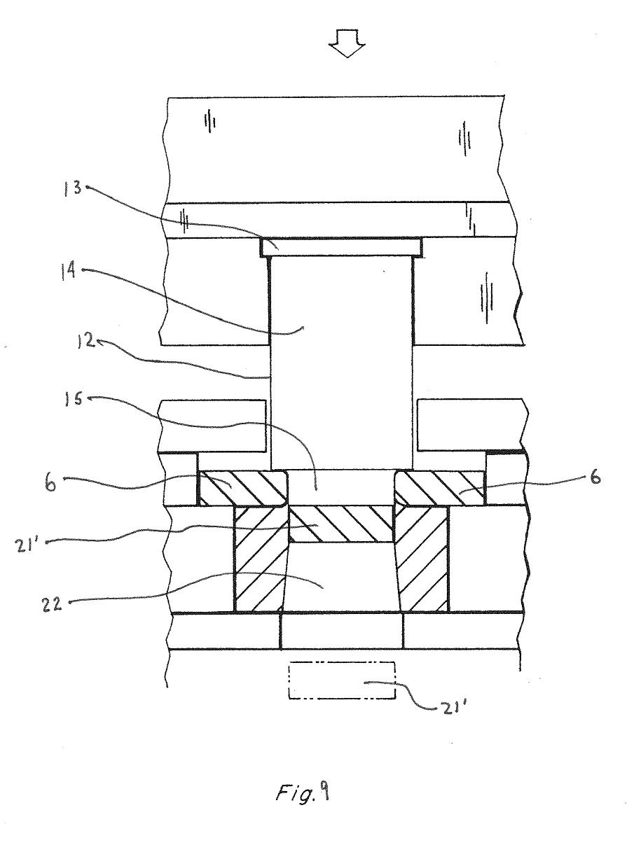

The dimensions and details of the top and bottom radii are shown and described below. The design and manufacture of the inwardly curved top radius 9 as shown on FIG. 6 and inwardly curved bottom radius 11 as shown on FIG. 8 are the main features of this disclosure.

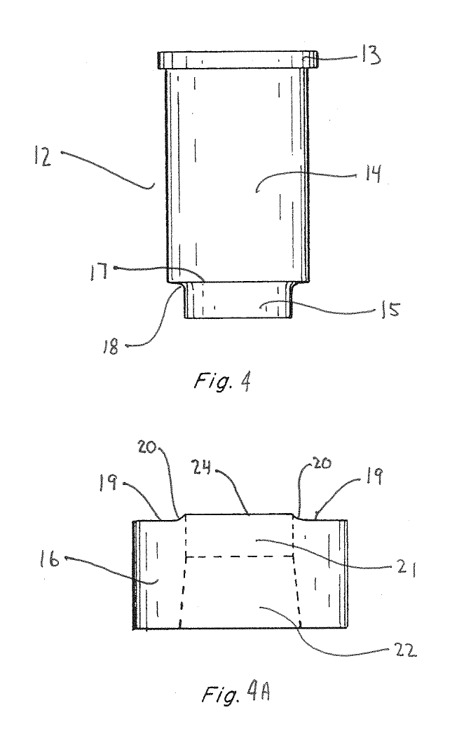

Turning now to FIGS. 4 and 4A, the two-piece punch and die button are shown. As shown in FIG. 4, the upper punch 12 is a unitary piece having a circular cross-section comprising an upper cap 13, a central body 14 and a lower hole punching section 15. The lower punching section 15 is the part of the upper punch that removes the metal from the blade 6 to form blade hole 7. The upper punch 12 is physically located above the lower die button piece 16 when the two-piece tool is operational, as best shown in FIG. 9.

Located under the lower edge 17 of the upper punch body 14 is a circumferential upper radius 18. The upper circumferential radius 18 extends along the entire circumference of the upper punch under the lower edge 17 of the central body 14. Part of this upper radius 18 is shown in detail in FIG. 5.

FIG. 4A shows the lower die button 1 piece 16. The lower die button 16 is a unitary piece having a generally circular cross-section. The circular top surface of the die button 16 comprises an outer flat circular surface 19 and a raised die button circumferential radius 20. The die button radius extends along the entire circumference of the top of the die button and is inside of the flat circular section 19 of the die button. The die button radius 20 is best shown in detail in FIG. 7.

The die button 16 is hollow, with the inner area of the die button removed. The upper cylindrical opening 21 of the inner area of the die button is best shown in FIG. 4A. The lower opening 22 of the inner area has a frustro-conical shape as shown. When the hole is punched in the metal blade by upper punch 12, the metal 21′ removed from the hole is forced through the hollow section 21 of lower die button 16 by the punch and falls out through the frustro-conical hollow area 22.

Turning now to FIGS. 5 and 6, the design, creation and manufacture of the upper radius 9 is shown. Referring to drawing FIG. 4, the lower left area of the upper punch 12 where the central body 14, lower edge of the punch 17, punching section 15 and upper radius 18 join is shown. The design and dimensions of the upper radius 18 of the upper punch 12 is an important feature of this invention.

After much experimentation, thought and analysis the discovery was made that the upper radius 18 is best designed as shown with a flat angle 23 of 14.15 degrees in the preferred embodiment and a radius of 0.075 inches. After much research it has been determined that the angle 23 of 14.15 degrees must be between 13.0 and 16.0 degrees. The upper radius should be between 0.070 and 0.080 in the preferred embodiment.

The upper punch 12 generally has an overall dimension of 3.991 inches. However this dimension is for information purposes only and is not meant to be a limitation on the invention. The lower hole punching section 15 of the die 16 is approximately 0.075 inches high and 1.54 inches in diameter. This dimension varies according to the end-user manufacturer specifications for the bolt hole size. However, the upper 18 and lower 20 radii of the hole remain as described and shown.

The upper radius 18 of upper punch 12 creates the top curvature or radius 9 of hole 7 in blade 6 as shown in FIG. 6.

Turning now to FIGS. 7 and 8, the design, creation and manufacture of the lower radius 11 is shown. Referring to drawing FIG. 7, the top of the upper left area of the die button 16 where the top outer flat circular surface 19 and the die button radius 20 join is shown. The design, dimensions and creation of the lower radius 11 of the blade hole 7 is critical to this invention.

After much experimentation, thought and analysis, the discovery was made that the lower radius 20 of die button 16 is best designed as shown with a lower radius 20 of 0.156 inches. After much research, experimentation and thought, this lower radius must be between 0.080 and 0.190 in the preferred embodiment. The die button 16 is cylindrical, having a top outer flat surface 19 and a hollow inner area 21 and 22. The distance from top flat circular surface 19 and the very top 24 of the die button, as best shown on FIG. 7, is 0.105 inches in the preferred embodiment. The inner diameter of the hollow section 21 is 1.556 inches plus 0.002 inches, although that dimension may vary depending on the end-user manufacturer specifications for the bolt hole.

The lower radius 20 of the die button 16 creates the bottom curvature or radius 11 of hole 7 in blade 6 as shown in FIG. 8.

This device is a two-piece punch 12 and die button 16 tool combination that punches a hole 7 in a blade 6 in one stroke. As best shown in FIG. 9, the upper punch 12 is located in a stroke apparatus. The lower die button 16 as aforesaid described is located beneath the upper punch 12. The blade 6 is positioned between the upper punch and lower die button in a suitable location. As the upper punch 12 is pressed downward by the apparatus, the lower hole punching section 15 of the punch 12 cuts out the metal it contacts and forms a separate cylindrical piece 21′. This cylindrical piece 21′ is forced through the cylindrical opening 21 of die button 16 and passes out through frustro-conical area 22 of the die button. The finished and separated metal cylindrical piece 21′ is shown in phantom lines 21′ at the very bottom of drawing FIG. 9.

The finished blade, shown in FIG. 3, has a hole 7 with dimensional characteristics as shown. The inner surface of the blade hole has the upper 9 and lower 11 radii as shown. The radii increase the strength of the blade at the hole due to the elimination or reduction of stress risers in the finished blade.

The dimensions described herein have been shown to be desirable in the preferred embodiment. The presence of the inner radii of the blade hole 7, particularly on the lower part of the blade, have been shown to increase the life of the blade and have the added feature of improved safety and less maintenance for the blades.

Having fully described my device, I claim:

1: A two piece punch and die button tool, comprising:
(a) an upper punch having a lower hole punching section with a circumferential upper radius; and
(b) a lower die button having a cylindrical hollow inner section and a circumferential lower radius.

2: A two piece punch and die tool as in claim 1, wherein the upper radius is 0.075 inches.

3: A two piece punch and die tool as in claim 1, wherein the upper radius is between 0.070 and 0.080 inches.

4: A two piece punch and die tool as in claim 1, wherein the lower radius is 0.156 inches.

5: A two piece punch and die tool as in claim 1, wherein the lower radius is between 0.080 and 0.190 inches.

6: A method of punching a hole in a cutter blade, comprising:
(a) placing an upper punch having a lower hole punching section with a circumferential upper radius as in claim 1 above a blade;
(b) placing a lower die button having a cylindrical hollow inner section and a circumferential lower radius below said blade;
(c) forcing said upper punch through said blade in one stroke;
whereby a blade having a hole with upper and lower circumferential radii is formed.
